(19) United States
(12) Patent Application Publication
(10) Pub. No.: US 2014/0279247 A1
(43) Pub. Date: Sep. 18, 2014

(54) PROVIDING CONTENT FOR TOURING POINTS-OF-INTEREST OF A REAL PROPERTY ASSET

(71) Applicant: AUCTION.COM, LLC, Irvine, CA (US)

(72) Inventors: Jennifer Leuer, Irvine, CA (US); John Hood, Irvine, CA (US)

(73) Assignee: AUCTION.COM, LLC, Irvine, CA (US)

(21) Appl. No.: 14/214,531

(22) Filed: Mar. 14, 2014

Related U.S. Application Data
(60) Provisional application No. 61/800,579, filed on Mar. 15, 2013.

(51) Int. Cl. G06Q 50/16; G06Q 30/06

(52) U.S. Cl. CPC G06Q 50/16; G06Q 30/0623
USPC 705/26.61

(57) ABSTRACT

A method for facilitating a tour of an asset through use of a mobile computing device is provided. A user brings the mobile computing device into geographic proximity of the asset. One or more processors determine a geographic correlation between a location of the mobile computing device and a location of the asset. Based, at least in part, on the determined geographic correlation, a presentation of information relating to the asset is provided on the mobile computing device for use during an in situ tour.

### RELATED APPLICATION

This application claims the benefit of priority to Provisional Application No. 61/800,579 filed on Mar. 15, 2013, entitled PROVIDING CONTENT FOR TOURING POINTS-OF-INTEREST OF A REAL PROPERTY ASSET; the aforementioned priority application being hereby incorporated by references in its entirety.

### TECHNICAL FIELD

Examples described herein pertain generally to a system and method for providing a presentation for touring points of interest of a real property asset through use of computing devices.

### BACKGROUND

Marketing a real property asset for sale, such as residential or commercial real estate, often involves making the asset available for personal tours by would-be purchasers. The personal tours may be conducted privately by a prospective buyer and an affiliated agent, or through a public open house that is hosted by an agent. There are some instances where costs involved in asset transactions may be reduced by minimizing agent involvement.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 illustrates an example system for managing the creation and distribution of a presentation for touring an asset in situ through use of a mobile computing device;

FIG. 2 illustrates an example method for generating a points-of-interest presentation of an asset for use during a tour of the asset;

FIG. 3 illustrates an example method for distributing a points-of-interest presentation of an asset to a user for use during a tour of the asset; and

FIG. 4 is a block diagram that illustrates a computing device upon which examples described herein may be implemented.

### DETAILED DESCRIPTION

Examples described herein provide a system and computer-implemented method for generating and/or making available content (e.g., audio or display content) for accompanying a prospective buyer in touring a real property asset. An asset seller can provide information to generate the presentation from a computing device through use of an application interface, while a prospective asset buyer can operate a mobile computing device to deliver the presentation during an in situ tour of the asset.

According to an example, a prospective seller may be prompted by the application interface to enter a variety of inputs, including various forms of content type, such as text, images, and/or audio, that explains certain points of interest associated with the asset being toured. The content may be uploaded to a centralized web-based content server, and aggregated. The aggregated content may then be grouped, based on points of interest, into sub-content pages for sequencing during an in situ tour of the asset.

In some examples, the system can make available a presentation of points of interest for a given asset for use during a tour of the asset. A user brings a mobile computing device into geographic proximity of the asset. One or more processors detect a geographic correspondence between a location of the mobile computing device and the location of the asset. Based, at least in part, on the detected geographic correspondence, the presentation of the points of interest relating to the asset may be provided on the mobile computing device for use during the tour.

As used herein, an “asset” may refer to an interest in real property, such as residential or commercial real estate. Also as used herein, a “user” may refer to an individual operating a computing device. An example of a user may include an owner of a real property asset, an asset evaluator, a home inspector, an appraiser, etc.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component may include a program, a sub-routine, a portion of a program, or a software component or a hardware component capable of performing one or more stated tasks or functions. As used herein, a module or component may exist on a hardware component independently of other modules or components. Alternatively, a module or component may be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples of the invention can be carried and/or executed. In particular, the numerous machines shown with examples of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

FIG. 1 illustrates an example system, generally designated 100, that generates and distributes presentations for in situ tours of assets. The assets may be offered for sale through brokered, seller-managed, or auction-driven marketing channels. According to some examples, the system 100 can be implemented through software that operates on various computing platforms, such as a general-purpose computer, a web-based server, and/or mobile computing device. System 100 can also be implemented through other computer systems in alternative architectures (e.g., peer-to-peer networks, etc.). System 100 can also be configured to communicate with one or more services 170 that can, for example, provide a forum or online listing for transactions for assets.

In one example, the system 100 includes a seller interface 102 that may be accessed by a seller computing device 104 through a network connection 106. A request module 108 solicits information from the seller in the form of prompts. The prompts may be configured in a manner that facilitates grouping similar content together into points of interest. The information may include basic asset data 110 such as the asset square footage, number of bedrooms, number of baths, the types of appliances in the kitchen, aspects of the front and back yards, and so forth. However, the asset data 110 may include further details, such as distinctive features of the particular asset that may stand out, or certain features the seller wishes to highlight. In such examples, the seller may be enabled to provide details of specialized features of the asset, and the cost and/or materials used to build such features.

Further referring to FIG. 1, each of the data prompts may also have an accompanying prompt for audio information 112 that allows the seller to audibly explain aspects of each room—the kitchen, living room, bedroom(s), bathroom(s), the yard(s), etc. In a similar manner, the request module 108 may request image information in the form of photographs 114 or video 116 of each room or area to supplement the existing state of the room or area during the tour. A seller, or otherwise a representative or associate of the seller, can provide such photographs 114 or video 116 in response to the prompts. Alternatively, the seller interface 102 can provide a knowledgeable seller freedom in customizing the eventual presentation, or certain functions of the seller interface 102 can be automated. For example, the seller may be prompted to provide an address of the real property asset to be sold. In response to receiving the address, at least a portion of the asset data 110 may be pulled from a third party resource. Additionally or as an alternative, a custom prompt may be included to enable the seller to highlight any other features of the asset besides the basic information.

The user may be prompted for a street address which identifies a location of the asset. As an alternative or variation, ageocode 118 associated with the asset may be automatically retrieved from the computing device 104 over network 106 (assuming the device is resident at the asset), or may be determined through cross-referencing a street address to the corresponding GPS coordinates. As an addition or alternative example, the geocode 118 may be used to automatically pull data regarding the asset from a third party resource. In such variations, a prompt can be included that asks the seller whether he or she is located at the asset to be sold, and the address can be pulled by correlating the location of the computing device 104 with one or more third party resources that identify addresses and property information. Furthermore, based on the data retrieved, the asset data may include a current valuation or multiple current valuations of the asset.

Once the request module 108 is finished with the prompted data collection from the asset seller, the information may be aggregated and processed by a presentation generator 120. The presentation generator 120 includes a content correlator 122 that ties together and groups information relating to common points of interest within a dwelling or property. For example, information pertaining to the kitchen may frame one point of interest, while information relating to the living room may frame another point of interest. Points of interest, while often organized in terms of living areas, may also be categorized in other ways, such as architecture or design aspects, indoor aspects versus outdoor aspects, and so forth.

Once information is categorized into common points of interest, the information groupings may then be processed into pages that may be generated and sequenced by a content sequencer 124. The resulting content items that form the presentation may then be stored in a database 132 and associated with an identifier (such as a property address or geocode) unique to the asset. In some variations, the data collected by the request module is directly stored in the database 132 along with the associated presentation.

Prospective asset buyers looking to tour certain assets may find available asset information via an application interface 158 on a mobile computing device 130, which can link to the system 100 over network 156 and connect to a buyer interface 134. Accordingly, the application interface 158 connects the user through a network 156 to a web-based asset buyer interface 134.

In one example, collections of assets sorted in a configurable manner may be made available to prospective buyers through an asset listings table 138. The table provides a list of assets that may be the result of a database query performed via the buyer interface based on prompts presented to the prospective buyer. The listing results may be based on price, geography, or asset-type to name a few. The listing results may also identify dates and times that a given asset may be toured.

In some circumstances, the prospective buyer may already have a list of assets, may be interested in a single asset, or may already know of the tour date and time. If the prospective buyer arrives at the asset and engages the application interface 158, an auto-detect tour module 136 may be utilized. This involves the user mobile device 130 communicating geocode location information while proximate the location of the asset. The buyer interface 134, or a processor included, can compare the geocodes, and if a match is detected, may prompt the user for a confirmation in a desired downloading or streaming of the tour presentation associated with the asset.

The buyer interface 134 may also provide access to relevant sites of interest associated with the asset through the services module 170. Relevant sites may include a local city website 140 ore resource, a county records website 142 or resource, or other services as more fully explained below.

As a user initiates a given presentation, sequenced items of content and information concerning highlighted points of interest may be viewed and/or heard while touring the asset. For instance, as the prospective buyer gains access to the property, an audio recording may point attention to the “white picket fence” or “cul-de-sac” location and the “well-manicured lawn.” Additional audio might point out “raised ceilings in a foyer” as the prospective buyer enters through the doorway. Various rooms may also have separate audio discussions, and in some cases, prompts may provide a form of interactivity between the presentation pages and the actual sequence of the tour by the user. In some circumstances, the presentation may have a list of points of interest for the user to select as the point is encountered. Other examples may provide associated video or photos of a room or area during, for example, a holiday season so that a prospective buyer may envision how the given room or area may be utilized under different circumstances. In some situations, high-accuracy geocodes may identify changes in location within a few feet. Where such precise location data is available, the application may detect how a prospective buyer tours through the asset by detecting changes in the GPS coordinates given by the user mobile device, and thus may change the sequence of content based on how the buyer progresses through the asset in a dynamic manner.

Alternatively, the buyer interface 134 can provide a menu feature that enables the user to select different locations of the asset at any time. For example, the user may wish to know details of a particular room or feature of the asset prior to conducting the tour, and may select the auto tour feature of the particular asset to learn of such features prior to the tour. Also, the user may wish to “revisit” certain portions of the asset after a tour in order to compare toured asset features. Furthermore, during the tour, the user may wish to focus on one or more particular rooms or features of the asset, such as the garage or toolshed, while a counterpart touring the asset may wish to focus on other features, such as a master bedroom or kitchen. In such scenarios, each user can launch the application on each respective device and conduct separate virtual tours of the asset while conducting the same physical tour.

In one variation, as a prospective buyer progresses through the points-of-interest presentation, prompts are provided to give the user an opportunity to take notes. In some variations, the prompts may request specific information from the prospective buyer regarding certain desirable and/or undesirable characteristics that are encountered for each point of interest. While the notes serve a valuable function as a memory retention tool for the user, the notes can also be accessible by the buyer interface 134. The notes may provide feedback for use by the content correlator 122 regarding the more desirable and undesirable features highlighted in the presentation, or completely omitted. Thus, by analyzing the notes, the presentation may be subsequently modified in a manner that makes the asset more marketable. In certain examples, the user may be prompted to permit the system 100 to access these notes. In such examples, the user has the choice of whether or not to allow the system 100 to receive the notes as feedback.

In some examples, a service interface 160 may direct the presentations to one or more services 170 (e.g., to one or more computing devices or servers remote from system 100). In particular, the service interface 160 can use one or more network resources of the computing device to provide communications over a wireless network. The network resources can include, for example, a cellular data/voice interface to enable the device to receive and send network communications over a cellular transport. As an alternative or variation, the network resources can include a wireless network interface for connecting to access points (e.g., Wireless Fidelity 802.11(g) or 802.11(n)) or for using other types of wireless mediums (e.g., Wi-Max). The service interface 160 can also format the presentation from a first format to a second format based on the particular service 170 that is to receive a report of the particular asset in question (e.g., formatted as a PDF file, HTML file, or XML file, etc.).

The services 170 can include, for example, email services (so that the presentation can be provided to the user's and/or different parties' email addresses), banking services, real estate management services, governmental agencies, and/or online transactional services. For example, the presentation can be provided to the online transactional service (e.g., that provides a transaction medium in a networked environment) so that the presentation can be linked to an online listing for transaction for the asset. Users or individuals having an interest in the asset (e.g., a real estate agent, a buyer, a seller, a banker, etc.) can access the online listing for the transaction for the asset in order to view the presentation. In addition, because the presentation can include a plurality of images or videos that provide verification of an asset and the condition of the asset, system 100 can enable remote or virtual inspection of the asset.

As an addition or an alternative, system 100 can also provide a rating or feedback for the user that performs the in situ tour. For example, when the tour is completed, system 100 may prompt the user to evaluate the tour and determine a ranking (e.g., from one to ten) based on the content of the presentation and its usefulness in the tour.

Methodology

FIG. 2 illustrates an example method for generating a points-of-interest presentation used for in situ touring of an asset. A method such as described by an example of FIG. 2 can be implemented using, for example, components described with an example of FIG. 1. Accordingly, references made to elements of FIG. 1 are for purposes of illustrating a suitable element or component for performing a step or sub-step being described.

In FIG. 2, a seller is prompted to enter a variety of inputs, where the inputs are indicative of points of interest that are associated with the asset, at 210. The prompts enable the asset seller to provide basic factual data and optional image and/or audio data regarding the points of interest. A geocode specifying, for example, the GPS coordinates of the asset may also be provided.

Once the information is entered by the asset seller, an aggregation process takes place, at 220. Once aggregated, the information may be correlated or grouped together into like groups having a common point of interest, at 230. The correlation results in pages that may be displayed in a mobile computing device while a prospective buyer carries out an in situ tour of an asset. In variations, the correlating may be carried out by specifying the prompts in certain ways such that the answers are necessarily correlated. Once generated, the pages for the presentation are sequenced in a certain order and stored in the database. As noted above, in certain situations, feedback from a prospective asset buyer may be used to modify the underlying data for a given presentation, and possibly modify the presentation itself.

Retrieving the presentation may be carried out by steps set forth in FIG. 3. As a prospective buyer brings a mobile computing device with location services proximate to the asset and launches the in situ tour application interface 158, which is detected by system 100, at 310, the application may determine a geographic correlation between the mobile device and the asset, at 320. If the software detects the geographic proximity, at 330, a previously generated presentation associated with the asset may be downloaded or streamed to the prospective buyer for use during an in situ tour, at 340.

The downloaded or streamed presentation may then be referenced by the prospective buyer during the tour. For example, prompts from the application may direct the buyer to a given area of the property, at 360, where audio or text information detailing highlights of the area may be communicated via the mobile computing device. The prompts may be given in a predetermined sequence according to the sequence of presentation pages, chosen manually by the buyer through a list of points of interest generated by the application, or dynamically driven based on changes in geographic location of the buyer within the property.

Further, as noted above, the application may prompt the prospective buyer for notes or thoughts on each point of interest, or on the property as a whole, at 370. The prompts might request feedback such as a rating or request specific information such as “please comment on the amount of natural light entering the room.” The notes and/or feedback may then be uploaded to the system 100 and/or made available to the seller to change aspects of the property presentation, at 380, or to change other marketing materials associated with the property.

Hardware Diagram

FIG. 4 is a block diagram that illustrates a computing device upon which examples described herein may be implemented. In one example, a computing device 400 may correspond to a mobile computing device, such as a cellular device that is capable of telephony, messaging, and data services. Examples of such devices include smartphones, handsets, or tablet devices for cellular carriers. Computing device 400 includes a processor 410, memory resources 420, a display device 430 (e.g., such as a touch-sensitive display device), one or more communication sub-systems 440 (including wireless communication sub-systems), input mechanisms 450 (e.g., an input mechanism can include or be part of the touch-sensitive display device), and a camera component 460. In one example, at least one of the communication sub-systems 440 sends and receives cellular data over data channels and voice channels.

The processor 410 is configured with software and/or other logic to perform one or more processes, steps and other functions described with implementations, such as described by FIGS. 1 through 3, and elsewhere in the application. Processor 410 is configured, with instructions and data stored in the memory resources 420, to operate, for example, a point-of-interest touring application as described in FIGS. 1 through 3. For example, instructions for operating the presentation application to display various user interfaces, such as described in FIGS. 1 through 3, can be stored in the memory resources 420 of the computing device 400. In one implementation, a user can operate the inspection application to conduct a tour of an asset. The user can provide one or more inputs 455 via the input mechanisms 450 so that the touring application provides presentation content 445 that is specific to the type of asset being toured. In some implementations, the user can interact with a touch-sensitive display 430 to make selections that are provided with one or more user interfaces and/or instructions 415.

In some examples, the user can operate (e.g., through use of the touring application) the camera component 460 to provide image data 465 that is to be included in the presentation for the touring of the asset. For example, one or more of the instructions 415 that are presented to the user can instruct the asset seller to take an image related to the asset. The camera component 460 can provide image data 465 that corresponds to a scene that the asset seller wishes to capture an image of. Based on the user inputs corresponding to each of the instructions 415, the presentation application can generate a presentation 445. The generated report 445 can be provided to the communication sub-systems 440 to be transmitted or linked to other services. The communication sub-systems 440 can enable the computing device 400 to communicate with other servers and computing devices, for example, over a network (e.g., wirelessly or using a wireline). The presentation 445 can be communicated to other services that can use the report as part of an online listing for transaction for the asset. While FIG. 4 is illustrated for a mobile computing device, one or more examples may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the invention is not limited to those precise examples. As such, many modifications and variations will be apparent to practitioners skilled in this art. Accordingly, it is intended that the scope of the invention be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude the inventor from claiming rights to such combinations.

What is claimed is:

1. A computer-implemented method for facilitating a tour of a real property asset, the method being implemented by a user mobile computing device having one or more processors, the method comprising:
detecting a user launch of an in situ tour application to tour the real property asset; and
providing a presentation of the real property asset on a display of the user mobile computing device, the presentation including location specific content corresponding to at least an interior of the selected real property asset.

2. The computer-implemented method of claim 1, further comprising:
determining a geographic correlation between a location of the mobile computing device and a location of the real property asset;
wherein providing the presentation of the real property asset is performed automatically upon determining the geographic correlation.

3. The computer-implemented method of claim 1, further comprising:
in response to detecting the user launch, providing a plurality of listings corresponding to a plurality of real property assets; and
detecting a user selection of a listing corresponding to the real property asset;
wherein providing a presentation of the real property asset is performed in response to detecting the user selection of the listing corresponding to the real property asset.

4. The computer-implemented method of claim 2, further comprising varying the location specific content based on a changing location of the user within the real-property asset.

5. The computer-implemented method of claim 2, wherein determining the geographic correlation comprises comparing relative geocode data between the user mobile computing device and the real property asset.

6. The computer-implemented method of claim 2, wherein determining the geographic correlation comprises accepting a manual input confirming geographic correspondence between the mobile computing device and the real property asset.

7. The computer-implemented method of claim 1, wherein the location specific content includes points of interest of the real property asset.

8. The computer-implemented method of claim 1, wherein the location specific content varies automatically after a predetermined time interval.

9. The computer-implemented method of claim 1, wherein the presentation includes interactive features responsive to inputs provided by the user, the interactive features enabling the user to vary the location specific content.

10. The computer-implemented method of claim 1, further comprising recording content provided by the user in response to the provided presentation.

11. The computer-implemented method of claim 10, wherein the recorded content is uploaded to a system site that generated the presentation, the method further comprising:
accessing the recorded content; and
modifying the presentation based on the recorded content.

12. A computer-implemented method for generating a presentation of points of interest for a user touring a real property asset, the method being implemented by one or more processors and comprising:
prompting a seller for information associated with the real property asset, the information including media content relating to different points of interest of the asset;
aggregating the information associated with the asset; and
grouping the information into separate points of interest to be sequenced to a user during an in situ tour of the asset.

13. The computer-implemented method of claim 12, further comprising:
accessing feedback from a prospective buyer; and
modifying the presentation based on the accessed feedback.

14. The computer-implemented method of claim 12, further comprising:
automatically delivering the presentation to a prospective buyer in response to detecting a geographic proximity of the prospective buyer to the real property asset.

15. The computer-implemented method of claim 12, wherein the media content includes any of text, audio, and images.

16. A non-transitory computer-readable medium storing instructions that, when executed by one or more processors, cause the one or more processors to:
detect a user launch of an in situ tour application to tour the real property asset; and
provide a presentation of the real property asset on a display of the user mobile computing device, the presentation including location specific content corresponding to at least an interior of the selected real property asset.

17. The non-transitory computer-readable medium of claim 16, wherein the instructions, when executed by the one or more processors, further cause the one or more processors to:
determine a geographic correlation between a location of the mobile computing device and a location of the real property asset;
wherein providing the presentation of the real property asset is performed automatically upon determining the geographic correlation.

18. The non-transitory computer-readable medium of claim 16, wherein the instructions, when executed by the one or more processors, further cause the one or more processors to:
in response to detecting the user launch, provide a plurality of listings corresponding to a plurality of real property assets; and
detect a user selection of a listing corresponding to the real property asset;
wherein providing the presentation of the real property asset is performed in response to detecting the user selection of the listing corresponding to the real property asset.

19. The non-transitory computer-readable medium of claim 17, wherein the instructions, when executed by the one or more processors, further cause the one or more processors to:
vary the location specific content based on a changing location of the user within the real-property asset.

20. The non-transitory computer-readable medium of claim 16, wherein the location specific content includes points of interest of the real property asset.
